(19) United States
(12) Patent Application Publication
(10) Pub. No.: US 2005/0151731 A1
(43) Pub. Date: Jul. 14, 2005

(54) Multisystematic volume rendering image processing system

(75) Inventor: Kazuhiko Matsumoto, Tokyo (JP)

Correspondence Address: PEARNE & GORDON LLP, 1801 EAST 9TH STREET, SUITE 1200, CLEVELAND, OH, 44114-3108, US

(73) Assignee: ZIOSOFT, INC., Tokyo (JP)

(21) Appl. No.: 10/812,770

(22) Filed: Mar. 30, 2004

(30) Foreign Application Priority Data
Dec. 24, 2003 (JP) 2003-426575

(51) Int. Cl. G06T 15/00

(52) U.S. Cl. 345/419

(57) ABSTRACT

When a decision is made that a part or all of data processing carried out by an operative image data processing unit CS0 is switched to an image data processing unit CS1 as a switching destination, volume data Volume-1 the same as those handled by the operative image data processing unit CS0 is first transmitted from a volume data storage unit SS to the destination image data processing unit CS1, and additional information Mask-1 such as additional information contained in the operative image data processing unit CS0 is then copied to the destination image data processing unit CS1 so that the destination image data processing unit CS1 can execute the data processing.

### BACKGROUND OF THE INVENTION

The present invention relates to a structure of a multisystematic volume rendering image processing system and particularly to data transfer.

With the advance of image processing technology using a computer, the advent of CT (Computed Tomography) and MRI (magnetic Resonance Imaging) by which an internal structure of a human body can be directly viewed has brought about innovation in the medical care field and medical diagnosis using a tomographic image of a living body is widespread. In addition, as an example of technology of visualizing a complicated three-dimensional internal structure of a human body which would be otherwise difficult to be understood from a tomographic image, volume rendering for directly describing an image of a three-dimensional structure based on three-dimensional volumetric digital dataset of an object obtained by CT is used in medical diagnosis in recent years.

As an excellent technique of volume rendering, ray casting is known. The ray casting is a technique in which virtual rays from a virtual start point are cast into an object to form an image of the virtual rays reflected from the inside of the object on a virtual projection plane to thereby draw an image of a three-dimensional structure of the inside of the object in perspective. For example, a fundamental theory of the ray casting is described in “Introduction To Volume Rendering 1998 Hewlett-Packard Professional Books Barthold Lichtenbelt, Randy Crane, Chaz Naqvi isbn 0-13-861683-3”.

The ray casting will be described in brief.

A micro unit area as a constituent unit of a three-dimensional region of an object is referred to as “voxel”. Proper data indicating characteristic such as a density value of a voxel is referred to as “voxel value”. The object as a whole is expressed in voxel data as a three-dimensional array of voxel values. Generally, the three-dimensional array of voxel data is obtained by performing necessary interpolation on data of two-dimensional tomographic images which are obtained by CT and which are laminated in a direction vertical to a tomographic plane.

Virtual reflected rays corresponding to virtual rays cast into an object from a virtual start point are generated in accordance with opacity values set artificially relative to voxel values. In addition, in order to shade a virtual surface three-dimensionally, a gradient of the voxel data, that is, a normal vector is obtained so that a shading coefficient can be calculated from the cosine of an angle between each virtual ray and the normal vector. The virtual reflected ray is obtained by multiplying the intensity of the virtual ray cast into each voxel by the opacity value of the voxel and the shading coefficient. All the virtual reflected rays are accumulated along the virtual rays and calculated for all coordinates on the virtual projection plane to thereby form a virtual three-dimensional perspective image. The aforementioned calculation is referred to as “volume rendering”.

The volume rendering image obtained thus is a three-dimensional color image described by use of a large number of volume rendering parameters applied to target voxel data.

The volume rendering parameters contain: display control information such as scale-up factor, angle, position, etc.; color specifying information; correspondence information for indicating correspondence between voxel values and opacity values; mask information; and shading information. The aforementioned information is hereinafter referred to “additional information”.

In actual medical diagnosis, a user of a medical image processing system observes volume rendering images one by one from various points of view while successively updating setting of volume rendering parameters (additional information) applied to target voxel data. For example, the user sets opacity values in accordance with voxel data because the optimal opacity value varies according to a subject of diagnosis. Further, peripheral tissue to be an obstacle to observation may be removed or suitable colors-may be set according to tissues so that a noted region such as the affected part can be observed easily.

The user further has to make various troublesome operations to set such parameters. When optimal parameters are set so that a volume rendering image satisfying the diagnosis purpose can be obtained, the editing operation is terminated.

FIGS. 8 to 10 and FIGS. 11A and 11B show conventional structures of volume rendering image processing systems.

### (CONVENTIONAL EXAMPLE 1)

FIG. 8 shows Conventional Example 1 in which an image processing system is concluded by one computer.

In FIG. 8, SS is an abbreviation for “storage server”, CS is an abbreviation for “computation server”, and D is an abbreviation for “display”.

In Conventional Example 1, all steps (of storage, computation and display) of image processing using volume rendering are performed by a computer (which may include a plurality of CPUs). For example, a first image processing system No.1 operates as follows.

(1) When a user operates an input unit K1 of a display D1 so that a request to display an image is sent to a computation server CS1, the computation server CS1 requests a storage server SS1 to acquire a data list necessary for display of the image according to the request.

(2) The computation server CS1 acquires the data list from the storage server SS1.

(3) The computation server CS1 selects data necessary for display of the image according to the request from the acquired data list, and requests the storage server SS1 to acquire the selected data.

(4) The storage server SS1 sends the requested data to the computation server CS1. The computation server CS1 reads the data received from the storage server SS1 into its own memory.

(5) The computation server CS1 performs volume rendering (image data processing) based on the acquired data stored in the memory.

(6) The computation server CS1 sends a result of volume rendering to the display D1. The display D1, which is an output unit, displays the result on a display screen D10.

(7) While viewing the displayed medical image, the user operates the input unit K1 to send information (additional information) to the computation server CS1 in order to change the viewing angle, make blood vessels in the front invisible, change the color of a certain region or scale up the medical image.

(8) The computation server CS1 analyzes the additional information and starts volume rendering (image data processing) as long as necessary data are within the scope of the previous data which are already sent from the storage server SS1 and stored in the memory of the computation server CS1. When the previous data are insufficient, the computation server CS1 requests the storage server SS1 to make up for the deficit of data and starts volume rendering (image data processing) after receiving the deficit of data from the storage server SS1.

(9) The computation server CS1 sends a result of volume rendering to the display D1. The display D1 displays the result.

(10) The user sends next information (additional information) to the computation server CS1 while viewing the displayed medical image. The same steps as described above are repeated until the user acquires a desired image.

(11) When a desired image is acquired in this manner, the user makes diagnosis while viewing the image or prints out the image. The user then terminates the use of the image processing system.

As described above, in Conventional Example 1, all the necessary steps for display of the images can be carried out by the image processing system No. 1 alone.

Similarly, each of image processing systems No. 2 and No. 3 is the same as the image processing system No. 1 in that all the steps of volume rendering can be performed by one computer.

The structure of each image processing system according to conventional Example 1, however, has the following drawbacks.

Drawback 1: Data stored in each storage server SS are data for medical image (voxel data) and widely different in accumulated quantity (about several GB) from image data (pixel data) in the other field. Accordingly, when there are a plurality of image processing systems on a network environment, copies of large-capacity voxel data have to be placed in all of the storage servers SS1 to SS3 of the image processing systems No. 1, No. 2 and No. 3. This brings increase in cost and waste of resources.

Drawback 2: Since the memory capacity is insufficient for real-time processing the large-capacity voxel data, an available data capacity used in real time is limited (arrangement of the whole data area on a main memory is essential for real-time processing the data while keeping the original resolution power of the data without downsampling).

Drawback 3: Target data have to be transferred to all the storage servers SS (local storages) of the image processing systems No. 1, No. 2 and No. 3 in advance.

Drawback 4: Since each local storage is not large in capacity, troublesome management for ensuring the capacity (such as management for finding and deleting unnecessary data which are not used for a long time so as to make a capacity for new data) is unavoidable.

### (CONVENTIONAL EXAMPLE 2)

FIG. 9 shows Conventional Example 2 to solve the drawbacks inherent in Conventional Example 1.

For example, the structure of image processing systems shown in FIG. 9 is used on an image display network in a hospital. Data of images picked up are collected in one place in the center. When to be use, the data are transferred from the center to a computer in a trace-reading room or a conference room, computed and displayed. A common storage server SS is provided so that only image data large in volume can be stored in the common storage server SS. Computation servers CS and displays D other than the storage server SS are provided in computers (machines) respectively.

After each of the image processing systems acquires necessary voxel data from the storage server SS dynamically so that the voxel data are read in the memory of the image processing system, the image processing system performs volume rendering (Convention Example 2 is not substantially different from Conventional Example 1 except for data exchange between the image processing system and the storage server SS).

That is, the image processing system No.1 operates as follows.

(1) The image processing system No. 1 requests the storage server SS to acquire a data list.

(2) The image processing system No. 1 acquires the data list from the storage server SS.

(3) The computation server CS1 selects data necessary for display from the acquired data list and requests the storage server SS to acquire the selected data.

(4) The storage server SS sends the requested data to the computation server CS1. The computation server CS1 reads the data received from the storage server SS into its own memory.

(5) The computation server CS1 performs volume rendering based on the acquired data in its own memory.

(6) The computation server CS1 sends a result of volume rendering to a display D1. The display D1 displays the result. Since the following steps are the same as those in Conventional Example 1, they are omitted here.

In addition, when the image processing system No. 4 is operative too, the image processing system No. 4 also operates as follows.

(1) The image processing system No. 4 requests the storage server SS to acquire a data list.

(2) The image processing system No. 4 acquires the data list from the storage server SS.

(3) The computation server CS4 selects data necessary for display from the acquired data list and requests the storage server SS to acquire the selected data.

(4) The storage server SS sends the requested data to the computation server CS4. The computation server CS4 reads the data received from the storage server SS into its own memory.

(5) The computation server CS4 performs volume rendering based on the acquired data in its own memory.

(6) The computation server CS4 sends a result of volume rendering to a display D4. The display D4 displays the result.

Since the image processing systems No. 2 and No. 3 are inoperative, the aforementioned operations of the image processing systems No. 2 and No. 3 are suspended.

According to Conventional Example 2, only necessary voxel data to be edited in volume rendering need to be kept in each operative image processing system. Accordingly, Conventional Example 2 has merits that wasteful use of local storages is eliminated and that limitation in capacity of each local storage is relieved.

On the other hand, as a drawback of Conventional Example 2, available data capacity used in real time is still limited because the memory capacity is insufficient for real-time processing large-capacity voxel data (because computation resources in Conventional Example 2 are the same as those in Conventional Example 1).

In addition, the computation resources are not utilized effectively because the computation servers CS2 and CS3 of the systems No. 2 and No. 3 are suspended when the systems No. 1 and No. 4 in FIG. 9 are in use.

### (CONVENTIONAL EXAMPLE 3)

FIG. 10 shows Conventional Example 3.

In the structure of image processing systems shown in FIG. 10, a plurality of displays D1 to D4, a common storage server SS and a common computation server CS are provided. That is, the computation server CS for performing volume rendering, as well as the storage server SS for storing voxel data, is shared among the image processing systems. Each image processing system performs volume rendering and operates as follows.

(1) A display (e.g., D1) requests the storage server SS to acquire a data list through the computation server CS.

(2) The display (e.g., D1) acquires the data list.

(3) The display D1 selects desired data from the data list.

(4) The display D1 requests the computation server CS to perform volume rendering.

(5) The computation server CS reads data necessary for volume rendering from the storage server SS into its own memory and performs volume rendering.

(6) The computation server CS transfers an image as a result of volume rendering to the display D1.

(7) The display D1 displays the received image on a display screen.

Merits of the structure of the image processing systems are as follows.

Merit 1: Since computers used for displaying processing results need not have computation resources, the image display systems can be constructed at low cost.

Merit 2: Since computation resources can be allocated to a plurality of operating persons dynamically, the computation resources can be utilized more effectively than those in the structure of the image processing systems shown in FIG. 9.

On the other hand, a drawback of the structure of the image processing systems is as follows.

Drawback 1: When load is so light that the display D1 of the system No. 1 and the display D2 of the system 2 are connected, the storage server SS and the computation server CS can perform processing in a short time. When the systems No. 1, No. 3 and No. 4 are used simultaneously as shown in FIG. 10, or when the system No. 2 is connected additionally, both load due to data capacity (memory capacity) and computation load are, however, concentrated on the storage server SS and the computation server CS (the fact that computation power is limited is substantially the same as in Conventional Example 1) so that user-friendliness is spoiled because of slow computation speed.

### (CONVENTIONAL EXAMPLE 4)

FIGS. 11A and 11B show Conventional Example 4.

In Conventional Example 3 shown in FIG. 10, load imposed on the computation server CS is very heavy since there is only one computation server CS. Therefore, in the image processing systems shown in FIGS. 11A and 11B, a plurality of computation servers CS1 to CS3 (three computation servers in FIGS. 11A and 11B) are provided so that load can be distributed to the computation servers CS1 to CS3. In this structure, when an image is to be displayed actually, that is, when a desired image is to be displayed on any one of displays D1 to D3, processing is distributively allocated to idle one of the computation servers CS1 to CS3 or to lightest-load one among the computation servers CS1 to CS3 if all the computation servers CS1 to CS3 are operative. Assume now that the computation servers CS1 to CS3 operate as shown in FIG. 11A while the systems are used in this manner. That is, the computation server CS1 performs processing for the displays D1 and D3, the computation server CS2 performs processing for the display D2, and the computation server CS3 performs processing for the display D4.

Assuming that the computation servers CS2 and the display D2 are then suspended, computation resources cannot be utilized effectively because the computation server CS2 is inoperative though the computation server CS1 continues to perform processing for the displays D1 and D3 and the computation server CS3 continues to perform processing for the display D4, as shown in FIG. 11B.

In the image processing systems according to Conventional Example 4 in which distributed processing is allocated to idle one of the computation servers CS1 to CS3 or to lightest-load one among the operative computation servers CS1 to CS3 when a desired image is to be displayed on any one of displays D1 to D3, there may still cause a problem that computation resources cannot be fully utilized.

In order to solve the problem, an object of the invention is to provide a volume rendering image processing system in which computation resources can be utilized effectively in any condition to make operating efficiency of computation servers best and in which no stress is given to operating persons.

### SUMMARY OF THE INVENTION

(1) In order to solve the problem, according to the invention, there is provided a multisystematic volume rendering image processing system including a plurality of image data processing units, a plurality of image display units, one or more common volume data storage unit for storing volume data necessary for the image display units, and a computation server manager, wherein: the image data processing units receive volume data necessary for formation of images requested by the image display units from the volume data storage unit, process image data in accordance with image requests (concerning angle, position, etc.) issued from the image display units, and transmit image results to the image display units; the image display units each including an input section and an output section transmit the image requests entered through the input sections to the image data processing units, receive the image results processed by the image data processing units and output the image results to the output sections; the volume data storage unit transmits the necessary volume data to the image data processing units in accordance with requests issued from the image data processing units; and the computation server manager makes a decision to switch data processing for the plurality of image display units so that a part of the data processing performed by operative one of the image data processing units will be replaced by data processing performed by another suspended one of the image data processing units (in which the concept “suspended” includes a state of low load).

(2) According to the invention, there is provided a multisystematic volume rendering image processing system as defined in (1), wherein when the computation server manager decides the switching and the same volume data as those handled by the operative image data processing unit are not present in the suspended image data processing unit as a destination of the decided switching, the computation server manager performs controlling to transmit the volume data from the volume data storage unit to the destination image data processing unit and then copy additional information from the operative image data processing unit to the destination image data processing unit, and makes the destination image data processing unit execute the data processing (for image formation).

(3) According to the invention, there is provided a multisystematic volume rendering image processing system as defined in (1) or (2), wherein: when overload is imposed on computation of volume rendering which is being carried out by a first image data processing unit, the computation server manager judges whether a part of the volume rendering has to be handed over to a second image data processing unit having idle computation resources or not; and when a decision is made that the part of the volume rendering has to be handed over, the computation server manager performs controlling to transmit volume data handled by the first image data processing unit from the volume data storage unit to the second image data processing unit and copy additional information from the first image data processing unit to the second image data processing unit, and makes the second image data processing unit execute the data processing which is heretofore executed by the first image data processing unit.

(4) According to the invention, there is provided a multisystematic volume rendering image processing system as defined in (1) or (2), wherein: the computation server manager stores identification names of the volume data transmitted from the volume data storage unit and destination data processing units in a memory in advance; when the volume data storage unit is requested to send volume data, the computation server manager inquires of the memory whether the same volume data are already sent or not, after the volume data is sent from the volume data storage unit; when the same volume data are already sent, the computation server manager judges whether the volume data are collected to one of the data processing units or not; and when a decision is made that the volume data are collected to one of the data processing units, the computation server manager performs controlling to copy additional information from a data processing unit to be suspended to another data processing unit as a destination of handover of the volume data and make the handover destination data processing unit execute data processing which is heretofore executed by the data processing unit to be suspended.

### BRIEF DESCRIPTION OF THE DRAWINGS

FIGS. 1A to 1D show a first embodiment of the invention.

FIG. 2 shows a second embodiment of the invention.

FIG. 3 is a block diagram showing the invention.

FIG. 4 is a flow chart showing the invention.

FIGS. 5A and 5B show a third embodiment of the invention.

FIGS. 6A to 6C show a fourth embodiment of the invention.

FIGS. 7A to 7D show a fifth embodiment of the invention.

FIG. 8 shows image processing systems according to Conventional Example 1.

FIG. 9 shows image processing systems according to Conventional Example 2.

FIG. 10 shows image processing systems according to Conventional Example 3.

FIGS. 11A and 11B show image processing systems according to Conventional Example 4.

### DETAILED DESCRIPTION OF THE PREFERRED EMBODIMENTS

A best mode for carrying out the invention will be described below in detail with reference to the drawings.

(First Embodiment)

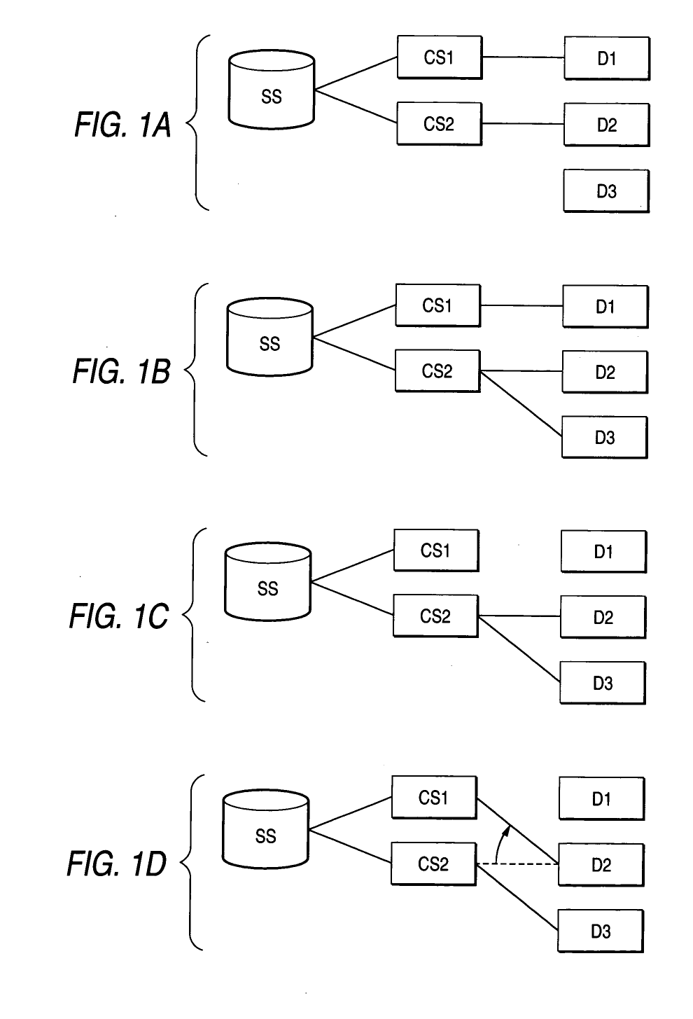

FIGS. 1A to 1D show an example of a volume rendering system which is switchable to correct imbalance and which is provided according to a first embodiment of the invention.

In FIGS. 1A to 1D, SS is an abbreviation for “storage server”, CS is an abbreviation for “computation server”, and D is an abbreviation for “display”. In the system shown in FIGS. 1A to 1D, one common storage server SS exerting excellent capability in accumulating huge data is provided while two independent computation servers CS1 and CS2 and three independent displays D1 to D3 are provided separately. Each computation server CS is a server having excellent computation power rather than data management.

Each display D is provided as a computer which does not perform data processing but is used exclusively for display. That is, the display D need not be provided as a high-end computer.

In FIG. 1A, first, data are loaded into the computation server CS1 from the storage server SS. When the loading is finished, the computation server CS1 performs volume rendering to form an image to be displayed in accordance with the request (angle, color, section, etc.) from the display D1. Similarly, after data are loaded into the computation server CS2 from the storage server SS, the computation server CS2 performs volume rendering to form an image to be displayed in accordance with the request from the display D2. The display D3 is not in use now.

In FIG. 1B, when the display D3 is used, for example, the computation server CS2 light in load at that time performs volume rendering on data loaded from the storage server SS to process the data into an image requested by the display D3, in parallel with original volume rendering to form an image to be displayed in the display D2.

In FIG. 1C, when the display D1 is suspended, the computation server CS1 is also suspended.

In FIG. 1D, the volume rendering for displaying an image on the display D2 is handed over from the computation server CS2 to the computation server CS1 without suspension of the computation computer CS1 in accordance with a decision made by a computation server manager CSM which will be described later (that is, without any instruction from an operating person) As a result, the computation server CS2 performs volume rendering for displaying an image on the display D3.

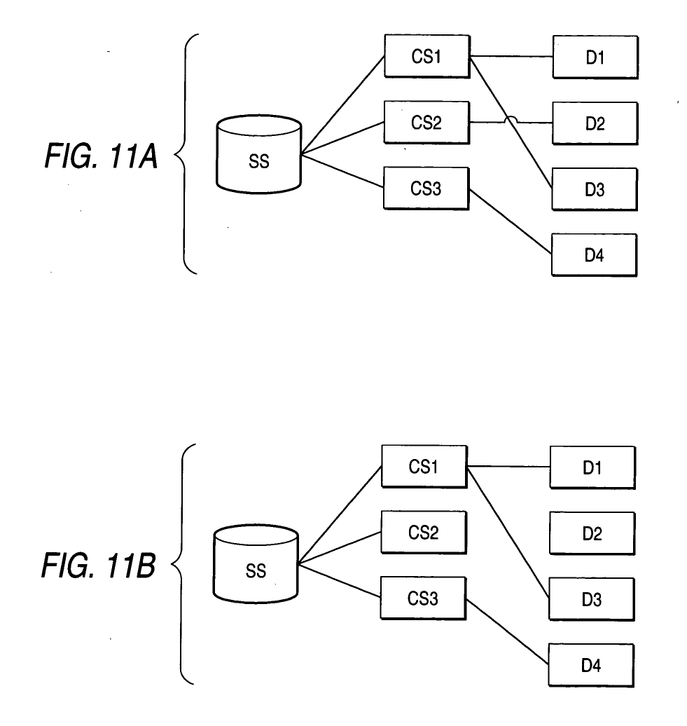

In this manner, according to the first embodiment, the computation server manager makes a decision that a part of data processing is switched from operative one of image data processing units to suspended one of the image data processing units to thereby effectively utilize computation resources. In Conventional Example 4 (shown in FIGS. 11A and 11B), when the inoperative display D2 is used again, the computation server CS2 in an inoperative state becomes operative to start volume rendering for displaying an image on the display D2. In Conventional Example 4, the computation server CS2 is however inoperative till the inoperative display D2 is used again. On the other hand, the first embodiment is widely different from Conventional Example 4 in that the suspended computation server CS2 does not become inoperative but immediately starts volume rendering for displaying an image on another display D.

Incidentally, the handover operation in the first embodiment is carried out as follows.

When data processing in one system is overloaded but data processing in another system gets in a light or no load state so that a part of the overload needs to be transferred to the latter system, contents of the memory of the former system are directly copied to the memory of the latter system and the data processing is then handed over from the former system to the latter system. This technique is used between ordinary image processing systems.

Because this handover technique is used in this embodiment, the computation server CS1 receives all data such as volume data for the display D2 from the computation server CS2 and then starts to perform volume rendering.

(Second Embodiment)

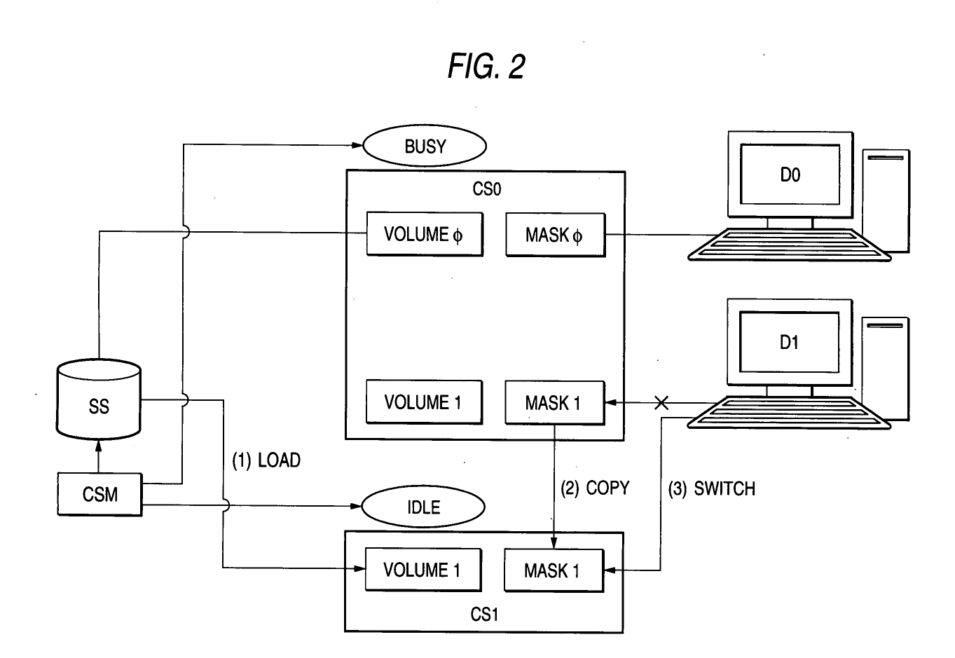

FIG. 2 shows a second embodiment of the invention for processing three-dimensional data which is huge in quantity such as volume data. According to the second embodiment, there can be obtained a volume rendering image processing system in which operating efficiency of computation servers is made best and in which the operating person does not feel stress at all.

In FIG. 2, SS is an abbreviation for “storage server”, CSM is an abbreviation for “computation server manager”, CS0 or CS1 is an abbreviation for “computation server”, and D0 or D1 is an abbreviation for “display”. FIG. 2 shows the case where volume rending which is performed for the display D1 by the computation server CS0 is handed over to the computation server CS1 because the computation server CS1 becomes idle while the computation server CS0 performs volume rendering for the two displays D0 and D1. According to the invention, the computation server manager CSM issues instructions for the following procedure and contents to the respective portions.

(1) The computation server manager CSM first issues an instruction to the computation server CS0 to make the computation server CS0 perform volume rendering for the two displays D0 and D1 continuously.

(2) In parallel with the instruction, the computation server manager CSM issues another instruction to the storage server SS to send volume data Volume-1 for the display D1 from the storage server SS to the computation server CS1.

(3) When sending of the volume data Volume-1 from the storage server SS to the computation server CS1 is finished, additional information Mask-1 such as additional information in the computation server CS0 at that time is copied from the computation server CS0 to the computation server CS1. The computation server CS1 then starts to perform volume rendering for the display D1.

(4) On the other hand, the computation server CS0 thereafter performs volume rendering for the display D0.

This invention has a feature in that special conditions of volume rendering image processing are used adroitly. The special conditions cannot be conceived for any other image processing system. That is, the special conditions are (1) a condition that volume data used in volume rendering image processing are very huge in quantity, (2) a condition that volume data imported into the memory of each computation server are not changed (read only), (3) a condition that the same data as volume data imported into the memory of each computation server are present in the storage server (that is, the volume data are sent from the storage server and not changed), and (4) a condition that additional information (mask data) about various display requirements such as angle of image, color of image and section of image always changes in accordance with calculation but is greatly smaller in capacity than the volume data.

This embodiment uses these special conditions adroitly. Because the computation server CS0 performs volume rendering for the two displays (display computers) D0 and D1 during the time when the huge volume data Volume-1 for the display D1 is sent from the storage server SS to the computation server CS1, the operating person feels no stress. Next, when the additional information Mask-1 is copied from the computation server CS0 to the computation server CS1, volume rendering is interrupted. However, since the quantity of the additional information is so small that a long time is not required for copying the additional information (generally, it takes a time of 2 sec to 5 sec), display delay is almost equal to display delay occurring at the time of heavy volume rendering. Thus, the operating person feels no stress. As a result, the operating person feels no stress in spite of the handover operation from the computation server CS0 to the computation server CS1. Furthermore, after the switching, processing speed becomes higher since load is distributed. Accordingly, the operating person feels comfort instead of stress.

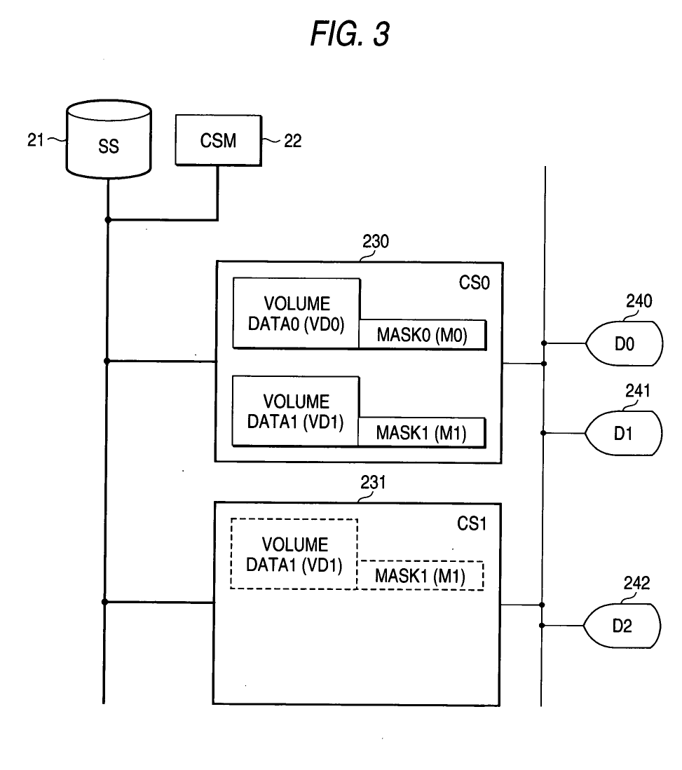

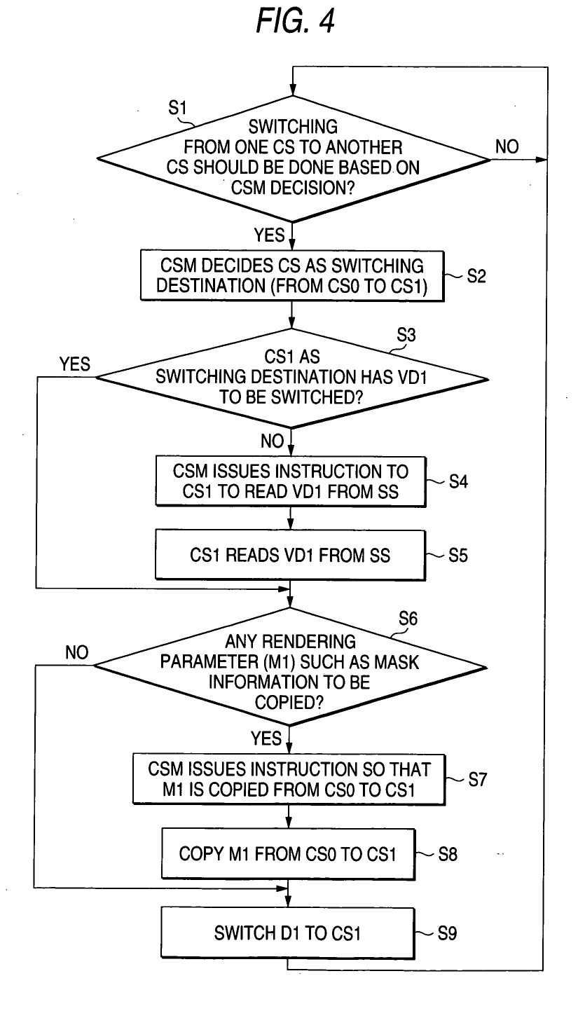

FIG. 3 is a block diagram showing the invention. FIG. 4 is a flow chart showing the invention.

In FIG. 3, the reference numeral 21 designates a storage server (SS); 22, a computation server manager (CSM); 230 or 231, a computation server (CS0 or CS1); and 240, 241 or 242, a display (D0, D1, or D2).

Volume data VD0, volume data VD1, additional information M0 and additional information M1 are loaded into a memory in the inside of the computation server CS0 while such data are not loaded into the computation server CS1.

In Step S1 in the flow chart of the switchable volume rendering system as shown in FIG. 4, when one of the computation servers CS is overloaded, the computation server manager CSM judges whether switching has to be performed to ask another computation server for assistance. When the computation server manager CSM decides that there is no need of switching, the current position of the routine returns to Step S1 so that the same judgment is repeated until there is a need of switching.

When a decision is made that there is a need of switching, the computation server manager CSM determines a computation server CS as a destination of the switching (Step S2). In the case of FIG. 3, assume that switching from the computation server CS0 to the computation server CS1 is determined. In Step S3, the computation server manager CSM searches for volume data VD1 to be switched to the computation server CS1 which is the switching destination. When there is no volume data VD1, the computation server manager CSM issues an instruction to the computation server CS1 to read the volume data VD1 from the storage server SS (Step S4). In Step S5, the computation server CS1 reads the volume data VD1 from the storage server SS. Then, the current position of the routine goes to Step S6. On the other hand, when a decision in Step S3 is made that there are volume data VD1 to be switched to the computation server CS1 which is the switching destination, the current position of the routine skips to Step S6 because it is unnecessary to read the volume data VD1 from the storage server SS.

In Step S6, the computation server manager CSM searches for additional information such as mask information (M1 in FIG. 3) to be copied. When there is no additional information to be copied, the current position of routine skips to Step S9. Otherwise, the current position of routine goes to Step S7. In Step S7, the computation server manager CSM issues an instruction to copy the additional information M1 from the computation server CS0 to the computation server CS1. In Step S8, the additional information M1 is copied from the computation server CS0 to the computation server CS1.

In step S9, the display D1 is switched from the computation server CS0 to the computation server CS1.

Then, the current position of routine returns to Step S1.

(Third Embodiment)

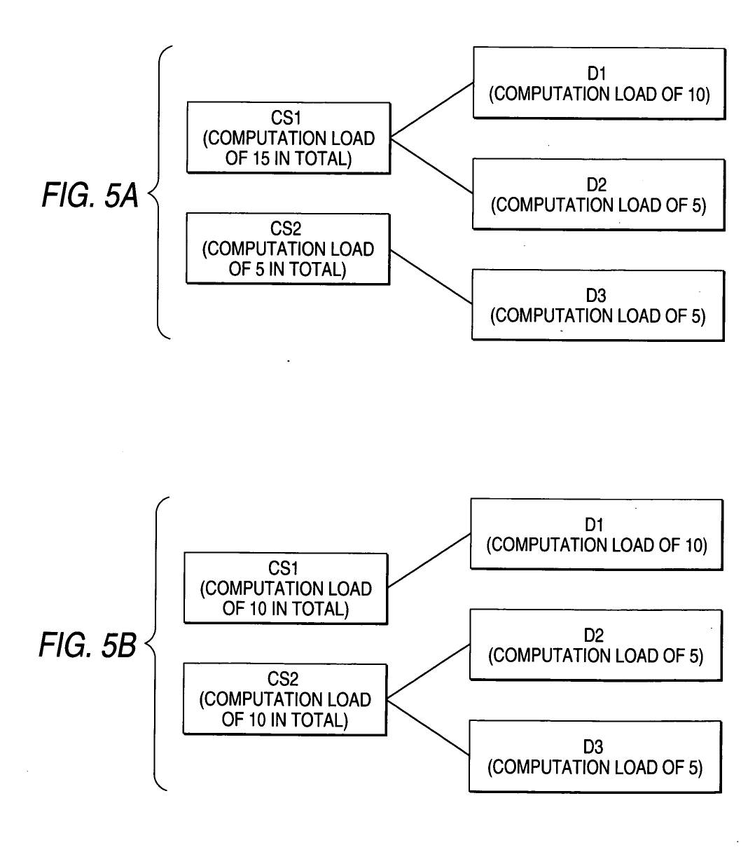

FIGS. 5A and 5B show a third embodiment of the invention, that is, shows an example of system configuration in which switching is decided so that computation resources can be utilized efficiently at the time of the switching.

FIG. 5A shows the relation of connection of the computation servers CS1 and CS2 with the displays D1 to D3 before the switching. FIG. 5B shows the relation of connection of the computation servers CS1 and CS2 with the displays D1 to D3 after the switching. FIGS. 5A and 5B will be described on the assumption that the computation servers CS1 and CS2 are equal in computation power to each other.

In FIG. 5A, the computation server CS1 handles calculation for the display D1 (calculation load of 10) and the display D2 (calculation load of 5), that is, the computation server CS1 bears a calculation load of 15 in total. On the other hand, the computation server CS2 handles calculation for the display D3 (calculation load of 5). In this case, the computation server CS1 bears a calculation load of 15 in total whereas the computation server CS2 bears a calculation load of 5 in total. Accordingly, there is imbalance in calculation load, so that computation resources of the computation server CS2 cannot be utilized effectively.

Therefore, as shown in FIG. 5B, calculation for the display D2 (calculation load of 5) is switched from the computation server CS1 to the computation server CS2. As a result, calculation load can be wisely distributed to the computation servers CS1 and CS2 at the 10:10 ratio, so that the computation resources can be utilized effectively.

Not to say, the method according to the invention can be used for the switching in this case. That is, volume data are sent from the storage server in advance, and additional information is copied from the computation server CS1 to the computation server CS2.

Although task management such as judgment of switching is performed by the computation server manager CSM, this task management is not shown in FIGS. 5A and 5B. Although one common storage server SS is provided, the storage server SS is not shown in FIGS. 5A and 5B.

In this manner, effective utilization of the computation resources can be achieved.

(Fourth Embodiment)

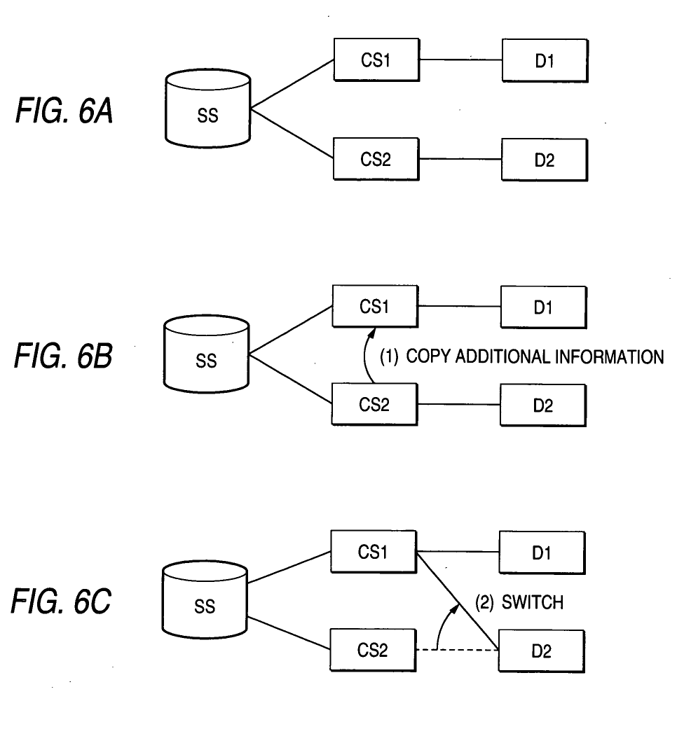

FIGS. 6A to 6C shows a fourth embodiment of the invention, that is, shows an example of system configuration in which switching is decided so that memory resources can be used efficiently at the time of the switching.

Although the second and third embodiments are described on examples about effective utilization of computation resources of the computation servers CS, the fourth embodiment will be described on an example about effective utilization of memory resources of the computation servers CS.

In FIGS. 6A to 6C, SS is an abbreviation for “storage server”, CS1 or CS2 is an abbreviation for “computation server”, and D1 or D2 is an abbreviation for “display”.

First in FIG. 6A, assume that the computation server CS1 performs volume rendering for the display D1 and the computation server CS2 performs volume rendering for the display D2. Assume further that the displays D1 and D2 use the same volume data but use different additional information.

The aforementioned situation often arises in a large hospital, etc. For example, volume data picked up at the department of radiology may be viewed simultaneously both in the internal department and in the surgical department. In this case, it is wasteful to load the same volume data into the two computation servers CS1 and CS2 as shown in FIG. 6A.

Therefore, in FIG. 6B, additional information for the display D2 is copied from the computation server CS2 to the computation server CS1.

Then, in FIG. 6C, the display D2 is connected to the computation server CS1. As a result, the computation server CS1 performs volume rendering for the two displays D1 and D2 to make the memory of the computation server CS2 empty. Accordingly, the computation server CS2 can be then used for performing volume rendering on volume data for another display than the displays D1 and D2.

In this manner, effective use of memory resources (memory function of idle computation servers) can be achieved.

In order to achieve the aforementioned operation on the system side automatically, identification names of volume data transmitted from the storage server SS and destination computation servers CS are stored in the computation server manager CSM in advance. When there is a transmission request after that, the computation server manager CSM judges whether the same volume data are sent or not. When the same volume data is already sent, the computation server manager CSM sends a notice of the presence of the volume data to the computation servers CS to avoid wasteful transmission of duplicated data.

In addition, the computation server manager CSM also examines whether the target computation server CS (which will take over volume rendering) has room for another volume rendering. When the target computation server CS has room, the computation server manager CSM uses the method according to the invention so that additional information for the computation server CS in which rendering is to be interrupted is copied to the target computation server CS and the display D is switched to the target computation server CS.

(Fifth Embodiment)

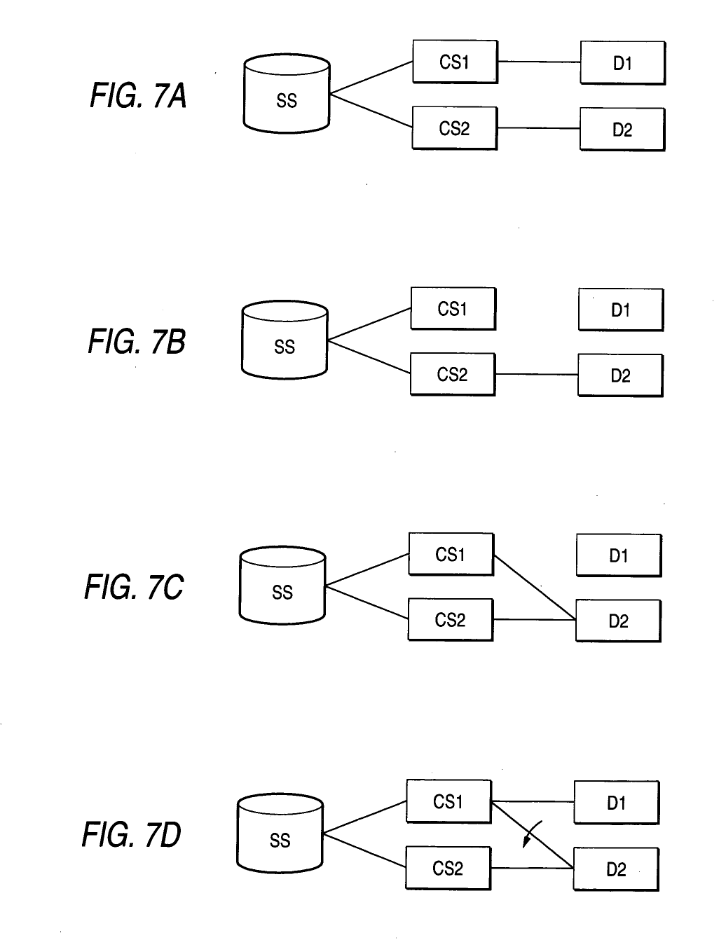

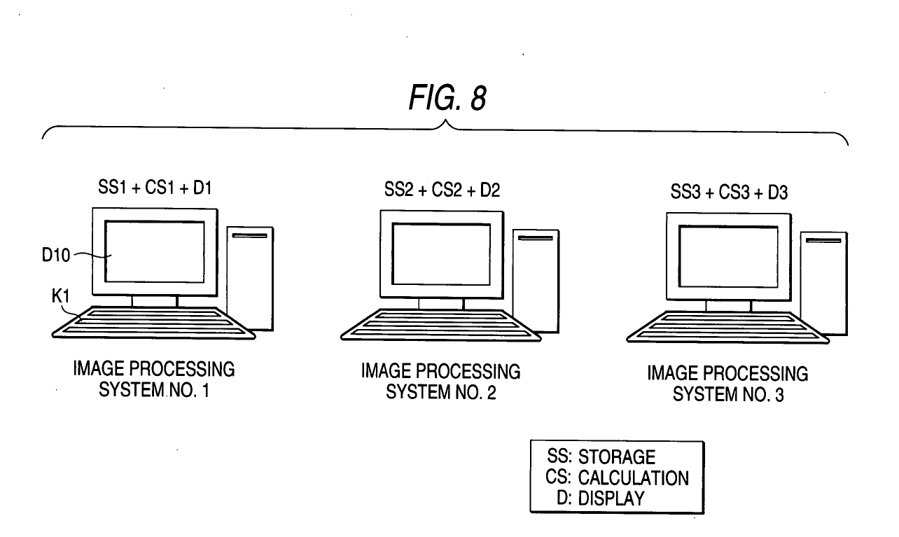

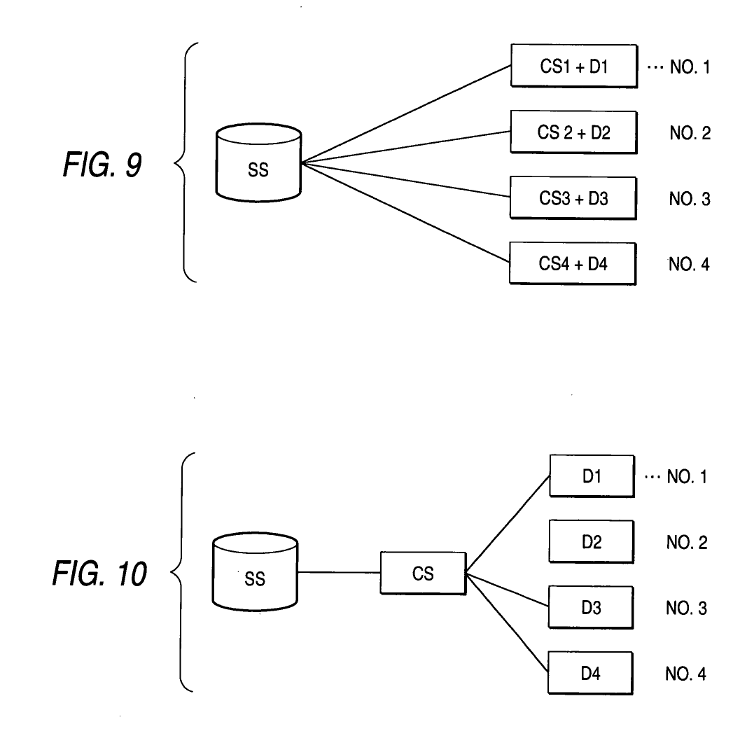

FIGS. 7A to 7D shows a fifth embodiment, that is, shows an example of clustering in which switching is decided so that capability of computation servers can be utilized fully.

In FIGS. 7A to 7D, SS is an abbreviation for “storage server”, CS1 or CS2 is an abbreviation for “computation server”, and D1 or D2 is an abbreviation for “display”.

First in FIG. 7A, assume that the computation server CS1 performs volume rendering for the display D1 and the computation server CS2 performs volume rendering for the display D2.

Then, assume that the computation server CS1 terminates volume rendering for the display D1 so as to be disconnected from the display D1 as shown in FIG. 7B.

In this state, the computation server CS1 is idle. Therefore, from the point of view of effective utilization, the display D2 is connected to the computation server CS1 to form clustering (assisting of volume rendering) as shown in FIG. 7C.

When the display D1 is connected to the computation server CS1 again, the clustering of the computation server CS1 is canceled as shown in FIG. 7D to return the system state to the state shown in FIG. 7A. Such a dynamic switching and disconnection technique is used for achieving effective use of the computation servers. It is a matter of course that volume data are sent from the storage server in advance by the method according to the invention at the time of switching. In this manner, the computing function of each idle computation server can be utilized more effectively.

Although FIG. 7D shows the case where the display D2 is disconnected from the computation server CS1, connection of the display D2 to the computation server CS1 may be continued so that the computation server CS1 can perform both processing for the display D2 and processing for the display D1 in a time sharing manner if load imposed on processing for the display D1 is light.

As described above, according to the fifth embodiment, capability of all the computation servers in the image processing system can be utilized to the utmost.

At the time of switching, it is a matter of course that the method according to the invention can be used so that volume data are sent from the storage server in advance, and that additional information for the source computation server CS which has performed volume rendering is copied to the destination computation server CS. Then, the destination computation server CS starts to perform volume rendering.

As described above, according to the invention, since a part of data processing performed for an image data display unit by an image data processing unit is switched to another image data processing unit suspended or light in load, operating efficiency of each computation server can be improved. In addition, at the time of the switching, volume data are sent from the volume data storage unit to an image data processing unit as a switching destination. Then, additional information is copied from the operative image data processing unit to the destination image data processing unit. Accordingly, the apparent switching time can be shortened, so that a volume rendering image processing system without any stress given to an operating person can be obtained.

With the structure, there can be obtained a volume rendering image processing system in which operating efficiency of computation servers can be made best and in which no stress is given to operating persons.

1. A multisystematic volume rendering image processing system comprising:
a plurality of image data processing units,
a plurality of image display units,
one or more common volume data storage unit for storing volume data necessary for the image display units, and
a computation server manager, wherein
the image data processing units receive volume data necessary for formation of images requested by the image display units from the volume data storage unit, process image data in accordance with image requests concerning angle and position issued from the image display units, and transmit image results to the image display units;
the image display units each including an input section and an output section transmit the image requests entered through the input sections to the image data processing units, receive the image results processed by the image data processing units and output the image results to the output sections;
the volume data storage unit transmits the necessary volume data to the image data processing units in accordance with requests issued from the image data processing units; and
the computation server manager makes a decision to switch data processing for the plurality of image display units so that a part of the data processing performed by operative one of the image data processing units will be replaced by data processing performed by another suspended one including a state of low load of the image data processing units.

2. The multisystematic volume rendering image processing system as claimed in claim 1, wherein
when the computation server manager decides the switching, if the same volume data as the volume data handled by the operative image data processing unit are not present in the suspended image data processing unit as a destination of the decided switching, the computation server manager performs controlling to transmit the volume data from the volume data storage unit to the destination imaged at a processing unit and copy additional information from the operative image data processing unit to the destination image data processing unit, and makes the destination image data processing unit execute the data processing.

3. The multisystematic volume rendering image processing system as claimed in claim 1, wherein
when overload is imposed on computation of volume rendering which is being carried out by a first image data processing unit,
the computation server manager judges whether to make a part of the volume rendering be handed over to a second image data processing unit having idle computation resources or not; and
when a decision is made that the part of the volume rendering is handed over, the computation server manager performs controlling to transmit volume data handled by the first image data processing unit from the volume data storage unit to the second imaged at a processing unit and copy additional information from the first image data processing unit to the second image data processing unit, and makes the second image data processing unit execute the data processing which is heretofore executed by the first image data processing unit.

4. The multisystematic volume rendering image processing system as claimed in claim 1, wherein
the computation server manager stores identification names of the volume data transmitted from the volume data storage unit and destination data processing units in a memory in advance;
when the volume data storage unit is requested to send volume data, the computation server manager inquires of the memory whether the same volume data are already sent or not, after the volume data is sent from the volume data storage unit; when the same volume data are already sent, the computation server manager judges whether the volume data are collected to one of the data processing units or not; and
when a decision is made that the volume data are collected to one of the data processing units, the computation server manager performs controlling to copy additional information from a data processing unit to be suspended to another data processing unit as a destination of handover of the volume data and make the handover destination data processing unit execute data processing which is heretofore executed by the data processing unit to be suspended.

5. The multisystematic volume rendering image processing system as claimed in claim 1, wherein
the image requests are data concerning to angle and position.
